(19) United States
(12) Patent Application Publication
(10) Pub. No.: US 2005/0050695 A1
(43) Pub. Date: Mar. 10, 2005

(54) Bungee Cord Hook

(75) Inventors: Eric Mackey, Milwaukee, WI (US); Mark Van Handel, Milwaukee, WI (US)

Correspondence Address: ERIC MACKEY, 3140 A WEIL STREET, MILWAUKEE, WI, 53212, US

(73) Assignee: MASTER LOCK COMPANY, Oak Creak, WI (US)

(21) Appl. No.: 10/711,251

(22) Filed: Sep. 3, 2004

Related U.S. Application Data
(60) Provisional application No. 60/481,334, filed on Sep. 4, 2003.

(51) Int. Cl. B65D 63/00; F16B 45/00

(52) U.S. Cl. 24/300; 24/598.4

(57) ABSTRACT

A bungee cord hook including one or more of a reversed hook orientation, a protection overmolded plastic coating, an angled base, a protective bumper, an angled hook portion and a size indication plate.

### CROSS-REFERENCE TO RELATED APPLICATIONS

This application claims the benefit under 35 USC §119(e) of U.S. Provisional Patent 60/481,334 filed Sep. 4, 2003, the entire disclosure of which is hereby incorporated by reference.

### BACKGROUND

The present invention relates to an improved hook for a bungee cord. Specifically, the improved hook for a bungee cord provides for easy anchoring or attachment of the hook.

Bungee cords typically comprise a stretchable cord and a hook fastened at either end. Bungee cords are used to secure a variety of items. Typically, one of the hooks is fastened to a secure object, or anchor point, and the stretchable cord is then secured over or around the object to be secured. The other hook then connects to a secure object, or anchor point, to maintain the cord in a taut position across or around the object to be secured.

Typical bungee cord hooks include a base portion and a curved hook portion. An object, or anchor point, is secured between the base portion and the curved hook portion. If the object to which the bungee cord hook is to be secured is relatively large, a user may have difficulty in getting the object between the base portion and curved hook portion. In addition, bungee cords need to be resilient to a variety of environmental conditions and easily identifiable so that a user uses the correct length of cord.

### SUMMARY OF THE INVENTION

The present invention relates to an improved bungee cord hook for a bungee cord that allows for easy anchoring or attachment of the hook to an object. In some embodiments the improved bungee hook provides an environmentally protective coating, a bumper that prevents damage of the anchoring object, or an indicator plate that provides information about the cord to which the hook is attached.

### DESCRIPTION OF THE DRAWINGS

In the accompanying drawings, which are incorporated in and constitute a part of this specification, embodiments of the invention are illustrated, which, together with a general description of the invention given above, and the detailed description given below serve to illustrate the principles of this invention.

FIG. 1 illustrates a bungee cord including two bungee cord hooks of the present invention.

FIG. 2 is a front view of a bungee cord hook of the present invention.

FIG. 3 is a side view of a bungee cord hook of the present invention.

FIG. 4 is a back view of a bungee cord hook of the present invention.

### DETAILED DESCRIPTION

The present invention is directed to an improved bungee cord hook, generally referenced as 10, that includes a reversed hook orientation, a protective outer coating, an angled base, a protective bumper and a size indication plate. While the preferred embodiment includes each of these features, as discussed below, one skilled in the art should recognize that such features may be used individually or in subcombinations to provide an improved bungee hook. As such, embodiments including the individual features and subcombinations of these features are contemplated by this invention and are covered within the scope of this application.

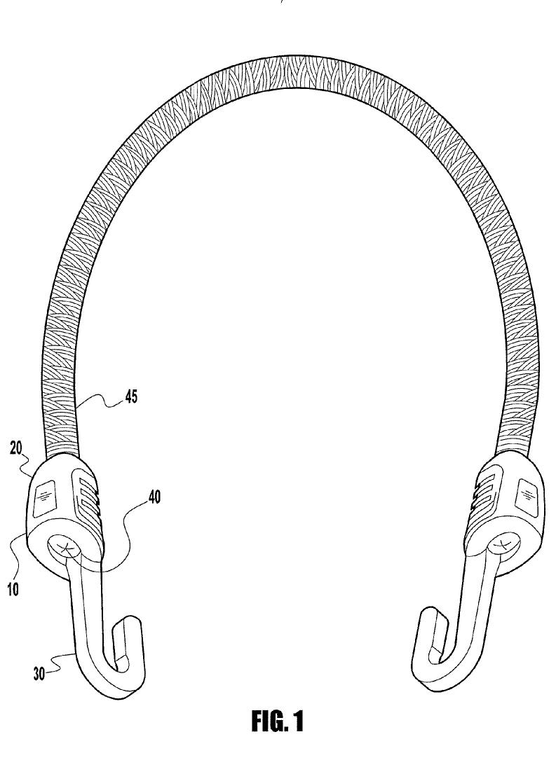

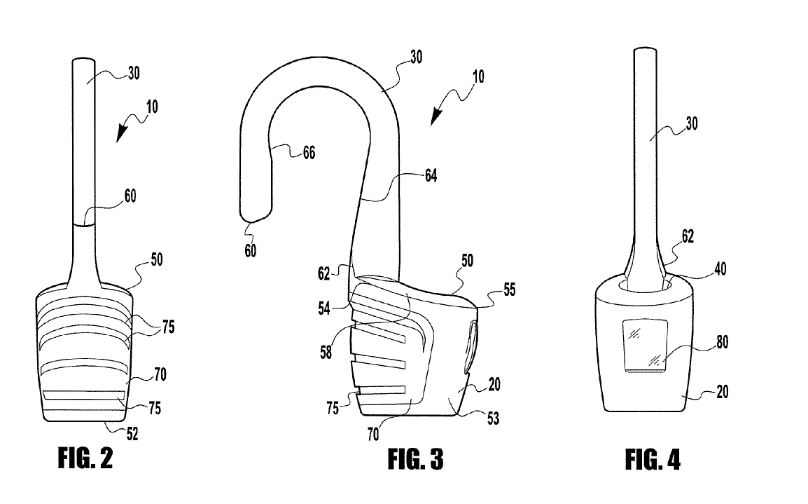

As shown is FIG. 1, the bungee cord hook 10 includes a base portion 20 and a hook portion 30. The base portion includes an aperture 40 or other securing mechanism that secures a bungee cord 45. The base portion 20 of the bungee cord hook 10 has a top end 50, a bottom end 52 and a circumferential surface 53 connecting the top and bottom ends. The top surface 52 has a first end 54 and a second end 56 and a generally angled surface 58 therebetween. The angled surface 58 allows for greater clearance and a more sleek design. Extending from the first end 54 is the hook portion 30 which is orientated such that the end of the hook 60 extends outward away from the base portion 20. This provides much more clearance than if the hook extend towards and hence over the base portion. The hook portion 30 may include a number of features that improves strength and performance. Illustrative example include, but are not limited to, a flared base portion 62 that provides rigid strength as the hook portion 30 attaches to the base portion 20, and angled back side portion 64 of the hook portion 30 that provides greater clearance for securing the hook to an object, and an angled surface 66 that assists in keeping the hook from sliding off an object to which it is secured.

The base portion 20 may include a protective bumper 70 that is located along a portion of the circumferential surface 53 that aligns with the first end 54 of the top end 50. The protective bumper 70 aligns with the hook portion 30 and may wrap partially around the circumferential surface 53. As such, when the hook portion 30 is secured to an object and the base portion 20 contacts the object, the contact will occur along the protective bumper 70. By wrapping the protective bumper 70 about a portion of the circumferential surface 53, the protective bumper 70 will contact the object when the bungee hook 10 twists onto its side. The protective bumper 70 may be any material that will not generally scratch or otherwise damage an object it contacts, such as, for example rubber, soft plastic, or other elastomeric composition. Additionally, the protective bumper 70 may include a set of grooves 75 that act as a gripping surface. The protective bumper 70 can be secured to the base portion 20 by any conventional means.

The bungee cord hook 10 generally is made from a rigid metal inner portion and a protective plastic coating applied on top of the metal portion. Typically bungee cord hooks are metal and may, or may not, include a thin elastomeric coating. Such coating is susceptible to tearing or cracking and does not provide protection for the metal portion against all of the environmental elements that a bungee cord is faced with. The protective plastic coating applied to the present invention is a think hardened overmolded plastic that is less susceptible to tearing, cracking or exposure of the metal portion contained therein.

The base of the bungee cord hook 20 further may include an indicator plate 80, preferably located opposite from the hook portion 30. The indicator plate 80 is preferably recessed from the circumferential surface 53. In some embodiments the indication plate 80 includes a protective clear plastic covering. The indicator plate 80 generally provides information about the bungee cord 10, such as, for example, the length of the cord.

The invention has been described with reference to the preferred embodiment. Clearly, modifications and alterations will occur to others upon a reading and understanding of this specification. It is intended to include all such modifications and alterations insofar as they come within the scope of the appended claims or the equivalents thereof.

1. A bungee cord hook comprising:
a base portion including a first and second end; and
a hook portion extending outward and away from said base portion.

2. The bungee cord hook of claim 1, wherein said hook portion includes a hook end and an angled portion, wherein said angled portion connects said hook portion with said base portion.

3. The bungee cord hook of claim 2, wherein said angled portion is angled back toward the base portion of the bungee cord hook.

4. The bungee cord hook of claim 1, wherein said base portion and said hook portion are comprised of overmolded plastic.

5. The bungee cord hook of claim 1, further comprising an indicator plate located on said base portion.

6. The bungee cord hook of claim 5, wherein said indicator plate is recessed within said base portion.

7. The bungee cord hook of claim 5, wherein said indicator plate is covered by a clear protective window.

8. The bungee cord hook of claim 1 further comprising a protective bumper.

9. The bungee cord hook of claim 8, wherein said protective bumper is located along a circumferential surface of said base portion.

10. The bungee cord hook of claim 9, wherein said protective bumper aligns with said hook portion.

11. The bungee cord hook of claim 8, wherein said protective bumper includes a set of grooves.

12. A bungee cord comprising:
(a) a stretchable cord; and
(b) a bungee hook secured to either end of said stretchable cord, wherein each of said bungee hooks comprise:
(i) a base portion including a first and second end; and
(ii) a hook portion extending outward and away from said base portion.

13. The bungee cord of claim 12, wherein said hook portion includes a hook end and an angled portion, wherein said angled portion connects said hook portion with said portion.

14. The bungee cord of claim 13, wherein said angled portion is angled back toward the base portion of the bungee cord hook.

15. The bungee cord of claim 12, wherein said base portion and said hook portion are comprised of overmolded plastic.

16. The bungee cord of claim 12, further comprising an indicator plate located on said base portion.

17. The bungee cord of claim 16, wherein said indicator plate is recessed within said base portion.

18. The bungee cord of claim 16, wherein said indicator plate is covered by a clear protective window.

19. The bungee cord of claim 12 further comprising a protective bumper located along a circumferential surface of said base portion.

20. The bungee cord of claim 19, wherein said protective bumper aligns with said hook portion.

21. The bungee cord of claim 19, wherein said protective bumper includes a set of grooves.

22. A bungee cord hook comprising:
(a) a base portion including a first and second end and a circumferential surface;
(b) a hook portion extending from said first end of said base portion; and
(c) an indicator plate formed in a recess in said circumferential surface of said base portion.

23. The bungee cord hook of claim 22 wherein said indicator plate provides information regarding the length of a cord attached to said bungee cord hook.

24. The bungee cord comprising:
(a) a stretchable cord; and
(b) a bungee hook secured to either end of said stretchable cord, wherein each of said bungee hooks comprise:
(i) a base portion including a first and second end and a circumferential surface;
(ii) a hook portion extending outward and away from said base portion;
(iii) an indicator plate formed in a recess in said circumferential surface of said base portion.
